(19) United States
(12) Patent Application Publication
(10) Pub. No.: US 2003/0141313 A1
(43) Pub. Date: Jul. 31, 2003

(54) Carton with dispenser

(76) Inventor: Aaron Bates, Marietta, GA (US)

Correspondence Address: Tsugihiko Suzuki, The Mead Corporation, 4850D North Church Lane, Smyrna, GA, 30080, US

(21) Appl. No.: 10/331,075

(22) Filed: Dec. 23, 2002

Related U.S. Application Data
(62) Division of application No. 10/015,285, filed on Dec. 12, 2001.
(60) Provisional application No. 60/255,543, filed on Dec. 12, 2000.

(51) Int. Cl. G07F 11/72; B65H 39/10; B65D 65/00; B65D 75/00

(52) U.S. Cl. 221/32; 271/303; 206/427; 221/31

(57) ABSTRACT

An enclosed carton has an exiting end capable of permitting articles to exit the carton. The carton comprises a bottom wall, a top wall and foldably connected adjoining side walls. The exiting end has a bottom end flap foldably attached to the bottom wall, a top end flap foldably attached to the top wall, a side end flap foldably attached to each side wall, and means for attaching the flaps together. The exiting end has a tear line for forming a dispenser opening. The tear line extends through the top wall at a distance spaced from the exiting end and extends at an angle through each side wall towards the exiting end to the attachment of each side wall with the side end flaps at a distance greater from the top wall than the bottom wall, with a fold line extending through each side end flap at a distance from the bottom wall. A handle is defined by a pair of apertures in the top wall that extend transversely towards the side walls.

This is a division of application serial No. 10/015,285, filed Dec. 12, 2001, which is hereby incorporated by reference and which claims the benefit of Provisional Application No. 60/255,543 filed Dec. 12, 2000.

### TECHNICAL FIELD OF THE INVENTION

The invention relates to cartons, and more particularly, to a carton for multiple articles having a dispenser for constrained removal of individual articles.

### BACKGROUND OF THE INVENTION

Cartons for encasing multiple articles are useful for enabling consumers to obtain and transport a desired quantity of individual articles such as soft drinks or other beverages. When such a multiple-pack of articles is obtained, a consumer frequently desires to remove one article from the carton at a time. Thus, it can be appreciated that it would be desirable to have a carton with a dispenser that facilitates the removal of a single article from the carton at a time.

When the articles contained in the carton are cylindrical, and are disposed in the carton upon their sides, it is important that the articles be constrained such that the remaining articles do not roll out of the dispenser when one is removed. It is also important that the dispenser provide a condition where the articles are easily accessed. It is further often desirable when removing individual articles from a carton to be able to determine how many articles remain in the carton. Thus, it can be further appreciated that it would be desirable to have a carton with a dispenser that constrains remaining articles so that they do not undesirably roll from or otherwise exit the carton when one article is removed. It can also be appreciated that it would be desirable to have a carton with a dispenser that facilitates access to the articles. It can be further appreciated that it would be desirable to be able to determine how many articles remain in a carton from which individual articles are removed.

### SUMMARY OF THE INVENTION

A carton of the invention has a dispenser for articles which can be substantially detached or torn away from the upper corner of the carton to expose an endmost article for removal.

According to the invention in one aspect, a carton is provided to comprise a plurality of walls defining an upper corner of the carton and an article dispenser for dispensing articles from the carton. The dispenser includes a displaceable portion of the carton formed from the upper corner and detachably connected to the walls to be substantially detached or tom away from the carton to define an opening for exposing an endmost article for removal. The dispenser comprises a constraining tab for inhibiting the endmost article from undesirably exiting the carton. The constraining tab extends upwardly to an elevation higher than the lowest point along the periphery of the opening. Th constraining tab is particularly of utility to inhibit cylindrical articles lying on their sides from undesirably rolling out from the carton.

According to a preferred embodiment, the displaceable portion of the carton is hingedly attached to the carton so as to provide a trough for receiving an article that exits the carton.

According to another preferred embodiment, the carton further comprises hand-hole punch-through means for grasping the displaceable portion. The punch-through means may be defined by weakened lines formed in one of the walls. The weakened lines may include a severance line and a fold line which together form a grasping panel that is foldably connected to the displaceable portion along the fold line.

According to a further preferred embodiment, the walls includes a top wall, opposed side walls connected to the side edges of the top wall and an end wall interconnecting the side walls, and the constraining tab is formed from the end wall. The constraining tab may be defined by an inverted U-shaped weakened line formed in the end wall. The lowest point along the periphery may be located adjacent to one or each of the opposite ends of the inverted U-shaped weakened line. The end wall may include a pair of overlapped side end flaps connected respectively to the side walls whereas the constraining tab may be formed from the side end flaps.

In the immediately above embodiment, the carton may further comprise a bottom wall connecting between the lower edges of the side walls. The end wall may comprise a bottom end flap connected to an end edge of the bottom wall and a pair of side end flaps connected respectively to adjacent end edges of the side walls. The lowest point may be located along a weakened line formed in the side end flaps while the constraining tab may be formed from part of the bottom end flap extending upwardly beyond the weakened line.

According to the invention in another aspect, a package is provided to comprise an article group formed of at least one tier of cylindrical articles disposed on their sides in a side-by-side parallel fashion, and a carton disposed around the group of articles. The carton comprises a top wall, a pair of opposed side walls connected to the top wall, an end wall interconnecting the side walls, and an article dispenser for dispensing the articles from the carton. The side walls are disposed alongside the ends of the articles of the group whereas the end wall is disposed adjacent to the side wall of an endmost article of the group. The dispenser includes a displaceable portion of the carton formed from and detachably connected to the top, side and end walls to be substantially detached from the carton to define an opening for exposing the endmost article for removal. The displaceable portion is connected to said side walls along tear lines that are disposed respectively across the opposite ends of the endmost article so that the opposite ends of the endmost article are partially exposed to facilitate access to themselves by a user when the displaceable portion is substantially detached from the carton.

In a preferred embodiment, the lines are disposed in the side walls and extend between the top wall and the end wall. The tear lines may be curved concavely toward the end wall to expose greater areas of the opposite ends of the endmost article when the displaceable portion is detached.

In another preferred embodiment, the tear lines are disposed in the side walls and extend downwardly from the top wall to the end wall. A lowest point along each of the tear lines may be spaced above the lower edge of the respective side wall at a distance no more than a half of the diameter of the endmost article. The dispenser may comprise a constraining tab for inhibiting the endmost article from undesirably exiting the carton. The constraining tab may be formed from the end wall and extend upwardly to an elevation higher than the lowest point along each tear line.

In a further preferred embodiment, the article group comprises two or more vertically arranged tiers of cylindrical articles. The articles in each tier may be disposed on their sides in a side-by-side parallel fashion, and the tear lines may be disposed across the opposite ends of an endmost article of the lowermost tier.

According to the invention in a further aspect, a package is provided to comprise an article group formed of at least one tier of cylindrical articles disposed on their sides in a side-by-side parallel fashion, and a carton disposed around the group of articles. The carton comprises a top wall, a pair of opposed side walls connected to the top wall, an end wall interconnecting the side walls, and an article dispenser for dispensing the articles from the carton. The side walls are disposed alongside the ends of the articles of the group while the end wall is disposed adjacent to the side wall of an endmost article of the group. The dispenser includes a displaceable portion of the carton formed from and detachably connected to the top, side and end walls to be substantially detached from the carton to define an opening for exposing the endmost article for removal. The displaceable portion is connected to the end wall along a weakened line extending between the side walls so that the weakened line defines the upper edge of a stopper wall formed from the end wall when the displaceable portion is substantially detached from the carton. The upper edge extends substantially along the cylindrical axis of the endmost article so that the stopper wall inhibits the endmost article from undesirably exiting the carton.

In a preferred embodiment, the carton further comprises a bottom wall connecting between the lower edges of the side walls, and the upper edge of the stopper wall is spaced above the bottom wall at a distance less than the diameter of the endmost article.

In another preferred embodiment, the dispenser comprises a constraining tab for inhibiting the endmost article from undesirably exiting the carton. Such a constraining tab may extend upwardly from the stopper wall. The weakened line may have an inverted “U” configuration so that the weakened line defines the constraining tab that is formed from the end wall.

In the immediately above embodiment, the carton may further comprise a bottom wall connecting between the lower edges of the side walls. The constraining tab may have a highest point along the upper edge while the highest point may be spaced above the bottom wall at a distance greater than a half of the diameter of the endmost article and less than the diameter. Alternatively, the carton may further comprise a bottom wall connecting between the lower edges of the side walls, and the upper edge has a lowest point at one or each of the opposite ends of the weakened line. Such a lowest point may be spaced above the bottom wall at a distance no greater than a half of the diameter of the endmost article.

According to the invention in a still further aspect, a carton is provided to comprise a plurality of walls defining an upper corner of the carton and an article dispenser for dispensing articles from the carton. The dispenser includes a displaceable portion of the carton formed from the upper corner of the carton and detachably connected to the walls of the carton to be at least partially detached from the carton to define an opening for exposing an endmost article in the carton for removal. The displaceable portion is hingedly connected to one of the walls for downward pivotal movement to an opened position so as to provide when in the opened position a trough for receiving an article that exits the carton.

In a preferred embodiment, the carton walls includes a top wall, a pair of opposed side walls connected to the side edges of the top wall and an end wall interconnecting the side walls. The displaceable portion may be formed from the top, side and end walls and hinged to the end wall along a fold line disposed parallel to the top wall. The carton may further comprise a bottom wall connecting between the lower edges of the side walls while the fold line is positioned closer to the bottom wall than to the wall so that at least part of the displaceable portion may lie in the plane of the bottom wall when the displaceable portion is brought into the opened position. This arrangement is of utility in that the trough provided by the displaceable portion can reach a support surface on which the carton is placed and thereby the trough may also sit on the support surface to be capable of receiving and supporting an article.

In the immediately above embodiment, the part of the displaceable portion to be in the plane of the bottom wall may comprise the upper edge of the end wall that is connected to the top wall. The fold line may extend entirely across the end wall. Alternatively, the fold line may be a weakened fold line curved or bent to take an essentially inverted-U shape. Such a weakened fold line remains partially unbroken to serve as a line of joinder when the displaceable portion is in the opened position.

Other advantages and objects of the present invention will be apparent from the following description, the accompanying drawings, and the appended claims.

### BRIEF DESCRIPTION OF THE DRAWINGS

FIG. 1 is an isometric illustration of a carton having a dispenser in accordance with a preferred embodiment of the invention,

FIG. 2 is an isometric illustration of the carton of FIG. 1 with the dispenser trough pivoted away from the upper portion of the end portion of the carton,

FIG. 3 is a plan view of a blank for forming the carton with the dispenser shown in FIG. 1,

FIG. 4 is an isometric illustration of a carton having a dispenser in accordance with a second embodiment of the invention,

FIG. 5 is an isometric illustration of the carton of FIG. 4 with the dispenser trough pivoted down to the opened position, and

FIG. 6 is a plan view of a blank for forming the carton shown in FIG. 4

### DETAILED DESCRIPTION OF THE PREFERRED EMBODIMENTS

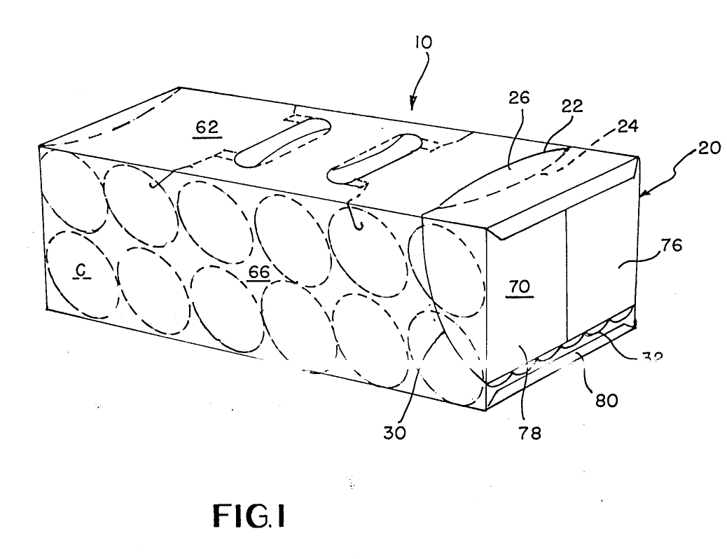

FIGS. 1 to 3 illustrate a first embodiment of the present invention. Throughout these drawings, the same reference numerals are used to denote the same or like features of the invention.

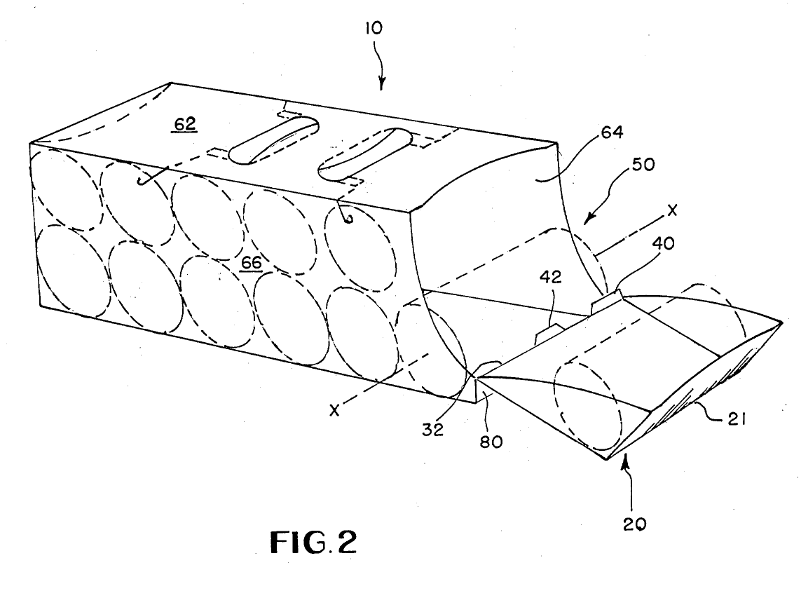

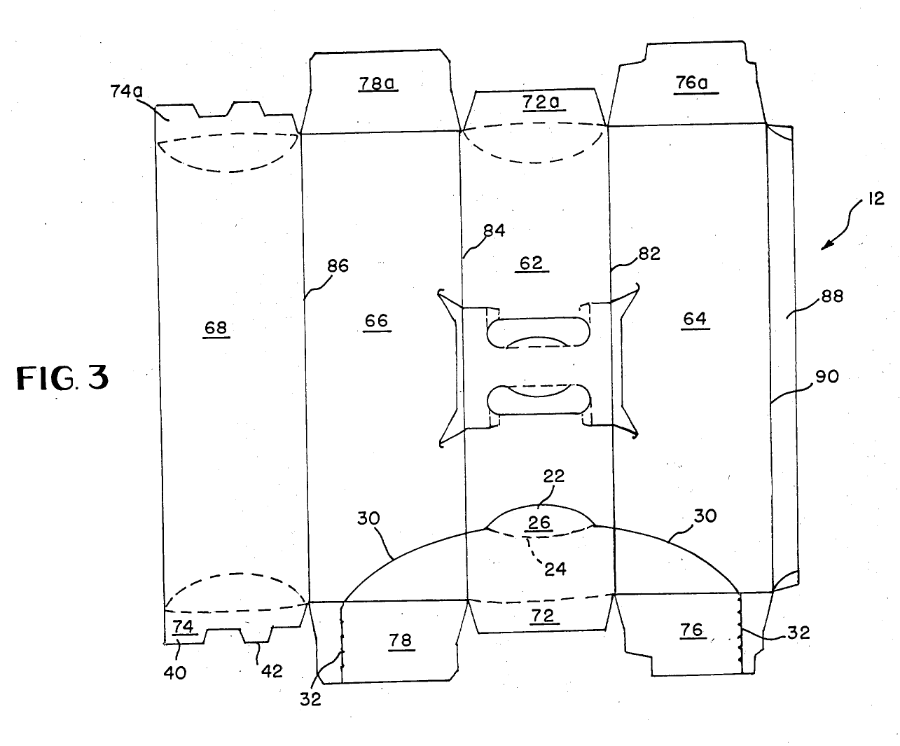

For convenience of understanding, reference may be made to FIGS. 1, 2 and 3 simultaneously. FIGS. 1 and 2 illustrate a carton 10 having a dispenser in accordance with the first embodiment. FIG. 3 illustrates the blank 12 from which the carton of FIGS. 1 and 2 is formed. Cans “C” arranged in a 6×2 array are shown in FIGS. 1 and 2 as an aid in understanding the invention. More specifically, the cans “C” are arranged in a group consisting of two vertically disposed tiers each including six cans. The cans “C” in each tier are disposed on their sides in a side-by-side parallel fashion.

Referring to FIG. 3, the blank 12 include four primary panels for forming the carton walls, i.e., a first side wall panel 64, a top wall panel 62, a second side wall panels 66 and a bottom wall panel 68 foldably connected one to the next along fold lines 82, 84 and 86. A glue flap 88 is foldably connected to the first side wall panel 64 along a fold line 90. Reference numerals 72, 72a, 74, 74a, 76, 76a, 78, 78a designate end flaps foldably connected the ends of the primary panels 62, 64, 66, 68. The end flaps arranged along each of the upper and lower edges (as viewed in FIG. 3) of the blank 12 form a composite end wall such as shown at 70 in FIG. 1.

To form an erected carton from the blank 12, the first side wall panel 64 is folded along the fold line 82 to lie flat on the top wall panel 62. Glue is applied to the glue flap 88, and then the bottom wall panel 68 is folded along the fold line 86 to lie flat on the second wall panel 66. By this means, the bottom wall panel 68 is glued to the glue flap 88, and thereby a flat tubular carton is provided. The flat tubular carton is then expanded into an open-ended tubular form. After cans are loaded through one or both of the open ends of the carton, the end flaps 72, 72a, 74, 74a, 76, 76a, 78, 78a are folded to form the respective end walls to thereby close the ends of the carton. To form the end wall 70, the top and bottom end flaps 72 and 74 are folded to their respective vertical positions. Glue is applied to the outside faces of the end flaps 72 and 74, and then the side end flaps 76 and 78 are folded in the described sequence onto the top and bottom end flaps 72 and 74. This causes the side end flaps 76 and 78 to be glued to the top and bottom end flaps 72 and 74. In the closed position show in FIG. 1, the side end flaps 76 and 78 overlap each other and are secured together also by means of glue. The other end wall (not shown) of the carton is formed in like manner by end flaps 72a, 74a, 76a and 78a.

An erected carton is shown in FIG. 1 wherein a trough 20 is integrally formed at an end portion of the carton 10 to be displaceable to form a dispenser. A hand-hole punch-through means for grasping the trough 20 is formed in the top wall 62 by a weakened line of severance 22 and a weakened fold line 24. Together, these two lines 22 and 24 form the hand-hole punch-through means and define an elliptical panel 26 on the cusp of the trough 20 adjacent the remainder of the carton 10 that can be grasped to pull down the trough 20 and reveal the dispenser area or opening 50. A weakened severance line or tear line 30 is formed in each of the opposed side walls 64 and 66 and extends from the top wall 62 to the composite end wall 70. In the preferred embodiment illustrated, the tear line lines 30 are of arcuate configuration. They are curved or arched concavely toward the end wall 70. The tear lines 30 intersect a frangible or otherwise weakened fold line 32 of joinder that is formed in the side end flaps 76 and 78 to extend between the side walls 64 and 66 entirely across the end wall 70.

Referring now particularly to FIG. 2, therein is illustrated the manner in which the trough 20 has been substantially removed from the carton 10 at the upper corner region and remains hingedly attached to the lower portion of the end wall 70 along the weakened fold line 32. With the trough 20 pivoted downward, the dispenser opening 50 is revealed. Constraining tab members 40 and 42 formed from the bottom end flap 74 are visible through the dispenser opening 50.

The cans “C” become accessible through the opening 50 by at least substantially detaching the trough 20 from the carton 10. Although the trough 20 can be completely removed by detaching it from the carton along the weakened fold line 32 that forms its hinge, when it remains attached, as shown, it serves as a handy mechanism for receiving an article (a can “C”), particularly when the dispenser is first opened. When the trough 20 is pivoted down to an opened position as shown in FIG. 2, the upper edge 21 of the end wall 70 is brought into contact with a support surface on which the carton is placed. This allows the trough 20 to be also supported by the support surface to be able to receive and properly support a can.

When the trough 20 is in the opened position or completely detached, the lower portion of the end wall 70 forms a stopper wall 80 that extend all the way between the side walls 64 and 66 along the cylindrical axis X-X (see FIG. 2) of the end most can of the lower tier adjacent the stopper wall 80. The upper edge of the stopper wall 80 is defined by the weakened fold line 32 that is spaced above the bottom wall 68 (see FIG. 3) at a distance less than the diameter of the cans “C”, and preferably no more than a half of the diameter of the cans “C”. The stopper wall 80 by itself is capable of inhibiting the cans on the lower tier from inadvertently exiting the carton before intended removal. However, an additional can stopper may be used. Such an additional stopper is provided by the constraining tab members 40 and 42. The respective upper or highest points on the tabs 40 and 42 may be disposed above the bottom wall 68 at a distance greater than a half of the diameter of the cans and less than the diameter of the cans. Thus, the constraining tabs 40 and 42 are shown in FIG. 2 as projecting upwardly beyond the upper edge 32 of the stopper wall 80. The contents of the carton are easily viewed through the dispenser opening 50.

Because each tear line 30 extends across the adjacent end of the endmost can “C” in the lower tier, the opposite ends of the endmost can “C” are partially exposed as shown in FIG. 2 so that a user can easily grasp that can by the opposite ends. The curvature of the tear lines 30 help to increase the exposed areas of the can ends. After the top, end-most can (the can “C” in the trough) is removed from the upper tier, the remaining cans C in the upper tier will nest in the spaces between the cans of the lower tier. Nesting of cans in this manner is well known in the art and is not illustrated. The invention serves as a useful dispensing carton that can be placed upon a surface or within a compartment such as a refrigerator or pantry.

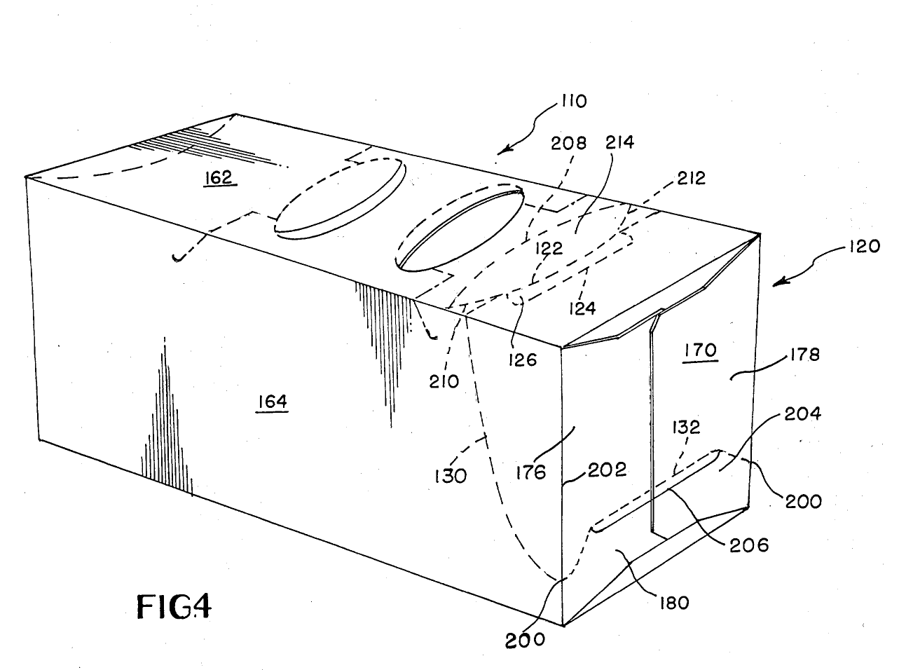

A second embodiment of the invention is shown in FIGS. 4 to 6, where like parts have been designated by the same reference numeral with the prefix “1” and only the differences are discussed in any greater detail.

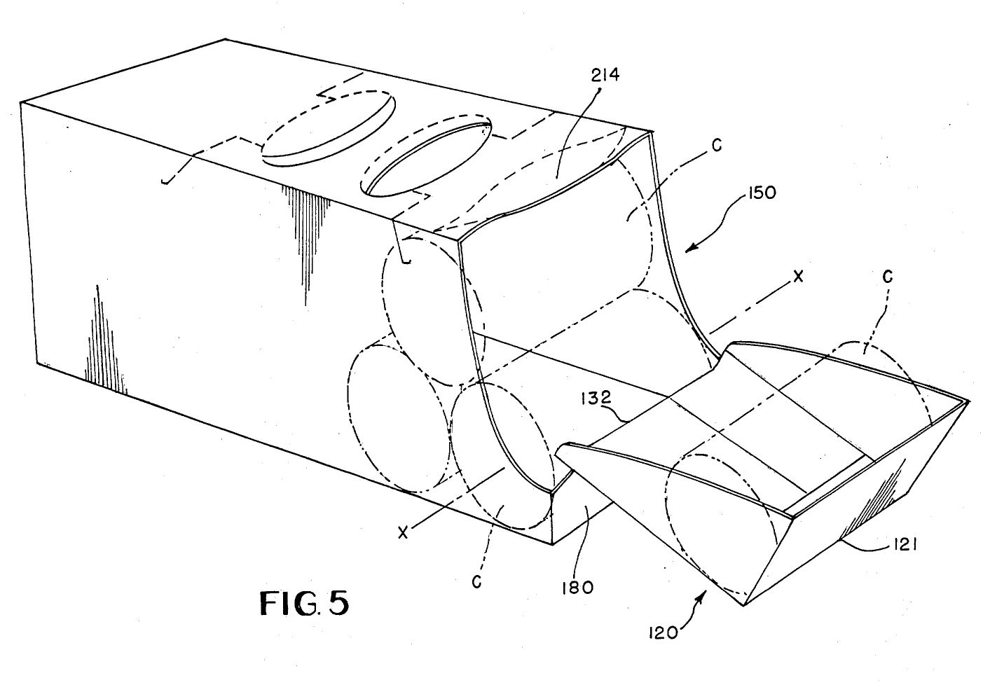

Referring to FIG. 5, cans “C” in this embodiment are arranged in a group consisting of two vertically disposed tiers each including five cans. The cans in each tier are disposed on their sides in a side-by-side parallel fashion.

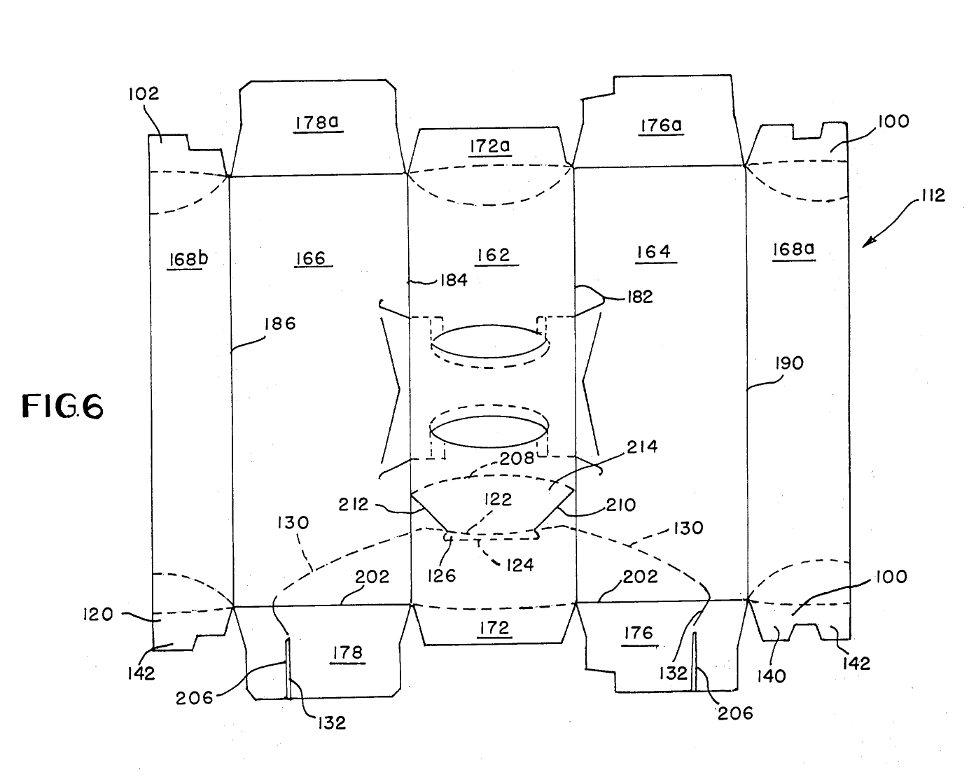

Referring to FIG. 6, the blank of the carton has a pair of bottom wall panels 168a and 168b that are secured together to form a composite bottom wall when the blank is erected into a carton. The inner or upper bottom wall panel 168a is foldably connected to the first side wall panel 164 along a fold line 190 while the outer or lower bottom wall panel 168b is foldably connected to the second side wall panel 166 along a fold line 186. Each bottom wall panel is provided at its opposite ends with end flaps 100 or 102. The end flaps 100 on the inner bottom wall panel 168a are glued respectively to the end flaps 102 on the outer bottom wall panel 168 to form full bottom end flaps similar to the end flaps 74 and 74a in the first embodiment.

FIG. 4 illustrates a carton 110 formed from the blank 112 of FIG. 6. The tear lines 130 extend from the top wall 162 to their respective lowest points 200 on the end edges 202 of the respective side walls 164 and 166. The lowest point 200 is spaced above the composite bottom wall at a distance, preferably, no more than a half of the diameter of the cans “C” to provide a maximum exposed area of the respective can end when the trough 120 is detached from the carton 110.

As shown further in FIG. 4, the weakened fold line 132 is curved, or bent, to assume an inverted “U” shape, which defines a constraining tab 204 along the upper straight portion of the weakened fold line 132. The lowest points on the weakened line 132 are located at its opposite ends 200 which are in registry with the lower ends of the tear lines 130. Therefore, the constraining tab 204 projects above the lowest points 200. The weakened line 132 is located above the composite bottom wall at a distance, preferably, greater than a half of the diameter of the cans “C” and less than the diameter of the cans “C”. Stated differently, the weakened fold line 132 is positioned considerably closer to the bottom wall than to the top wall 162. As best shown in FIG. 5, the weakened fold line 132 partially breaks near its opposite ends when the trough 120 is brought to the opened position; however, the straight portion of the line 132 remains unbroken to serve as a fold line.

Unlike the first embodiment, the tabs 140 and 142 (see FIG. 6) on the end flaps 100 and 102 do not project upwardly beyond the weakened line 132. However, they are disposed flat with the inside face of the constraining tab 204 and thereby function to reinforce the constraining tab 204.

Reference numeral 206 designate a half cut formed in the constraining tab 204 and extending along the weakened fold line 132. The half cut 206 may be used to facilitate removal of the trough 120 when it is desired to completely detach the trough 120 from the carton 110. Reference numerals 208, 210 and 212 designate fold lines formed in the top wall 162 to define an yielding panel 124. The yielding panel 214 is easily displaced downwardly when pressed downwardly. Therefore, the yielding panel 214 is useful to facilitate breaking of the severance line 122 during the process of grasping the trough 120 by the hand-hole punch-through means or elliptical panel 126. The stopper wall 180 is created in the same manner as in the first embodiment and extend entirely across the dispenser opening 150 along the cylindrical axis X-X (see FIG. 5) of the endmost can “C” of the lower tier.

Modifications may be made in the foregoing without departing from the scope and spirit of the claimed invention. For example, the dispenser may be formed at each end of the carton according to the invention. It should be also appreciated that as used herein, directional references such as “top”, “bottom”, “end”, “side”, “upper” and “lower” do not limit the respective panels to such orientation, but merely serve to distinguish these panels from one another.

It should be further appreciated that any reference to hinged or foldable connection should not be construed as necessarily referring to a single fold line only: indeed, it is envisaged that hinged connection can be formed from one or more of one of the following, a score line, a frangible line or a fold line, without departing from the scope of invention.

What is claimed is:

1. An enclosed carton for carrying a plurality of articles, the carton having two ends, at least one of the ends being an exiting end capable of permitting articles to exit the carton one at a time, the carton comprising:
a bottom wall, a top wall and foldably connected adjoining side walls;
said exiting end having a bottom end flap with a height and which is attached by a fold line to the bottom wall, a top end flap foldably attached to the top wall, a side end flap foldably attached to each side wall, and means for attaching said flaps together to close the exiting end of the carton;
said exiting end having a tear line for forming a dispenser opening, said tear line extending through the top wall at a distance spaced from and generally parallel to the exiting end and extending at an angle through each side wall towards the exiting end to the attachment of said each side wall with a respective one of said side end flaps at a distance greater from the top wall than the bottom wall, with a fold line extending through each side end flap at a distance from the bottom wall, so that when the tear line is tom, a dispenser opening is formed for dispensing articles, with the dispenser remaining attached to the carton by the fold line through each side end flap, so that the bottom end flap and a portion of each side end flap adjacent to the bottom end flap remain attached to the carton, said dispenser forming a trough for receiving articles exiting the carton;
means for closing the other end of the carton; and
a handle defined by a pair of apertures in the top wall, the apertures extending transversely towards the side walls.

2. The carton of claim 1 in which the tear line in the top wall extends away from the exiting end for a portion of its extension across the top wall to form a finger flap foldably attached to the dispenser to facilitate commencing opening the dispenser in the top wall.

3. The carton of claim 1 in which glue is used to close both ends of the carton.

4. The carton of claim 1 in which there is only one exiting end.

5. The carton of claim 1 in which both ends are exiting ends.

6. An enclosed carton for carrying a plurality of articles, the carton having two ends, at least one of the ends being an exiting end capable of permitting articles to exit the carton one at a time, the carton comprising:
a bottom wall, a top wall and foldably attached adjoining side walls;
said exiting end having a bottom end flap with a height and which is attached by a fold line to the bottom wall, a top end flap foldably attached to the top wall, a side end flap foldably attached to each side wall, and means for attaching said flaps together to close the exiting end of the carton;
said exiting end having a tear line for forming a article dispenser, said tear line extending through the top wall at a distance spaced from and generally parallel to the exiting end and extending at an angle through each side wall towards the exiting end to the attachment of said side wall with a respective one of said side end flaps at a distance greater from the top wall than the bottom wall, said tear line extending through each side end flap at a distance from the bottom wall so that an opening for dispensing articles is formed when the tear line is torn, said bottom end flap and the bottom portion of each side end flap remaining attached to the carton;
means for closing the other end of the carton; and
a handle defined by a pair of apertures in the top wall, the apertures extending transversely towards the side wall.

7. The carton of claim 6 in which the tear line in the top wall extends away from the exiting end for a portion of its extension across the top wall to form a finger flap foldably attached to the dispenser to facilitate commencing opening the dispenser in the top wall.

8. The carton of claim 6 in which glue is used to close both ends of the carton.

9. The carton of claim 6 in which there is only one exiting end.

10. The carton of claim 6 in which both ends are exiting ends.

11. A dispenser for cartons for carrying a plurality of articles wherein said carton has two ends, at least one of the ends being an exiting end capable of permitting articles to exit the carton one at a time, the dispenser being a part of a carton comprising:
a bottom wall, a top wall and foldably attached adjoining side walls, said top wall having a handle defined by a pair of apertures in the top wall, the apertures extending transversely toward the side walls;
said exiting end having a bottom end flap having a height and which is attached by a fold line to the bottom wall, a top end flap foldably attached to the top wall, a side end flap foldably attached to each side wall, and means for attaching said flaps together to close the exiting end of the carton; and
means for the other end of the carton wherein said dispenser is formed in the exiting end of the carton, said dispenser having a top end flap formed from a portion of the top wall adjacent the exiting end, a side end flap formed from a portion of each side wall adjacent the exiting end, said side end flap having an edge that extends at an angle towards the exiting end to the attachment of said each side wall with the side end flap at a distance greater from the top wall than the bottom wall when the dispenser is a part of the carton, and when the dispenser is open the dispenser remains attached to the carton by a fold line through each side end flap so that a portion of each side end flap adjacent to the bottom end flap remains attached to the carton, said dispenser forming a trough for receiving articles exiting the carton.

12. The dispenser of claim 11 which has a finger flap foldably attached to the top flap.
